(19) United States
(12) Patent Application Publication
(10) Pub. No.: US 2005/0271398 A1
(43) Pub. Date: Dec. 8, 2005

(54) Photo-detector arrangement and process for the calibration thereof

(76) Inventor: Ulrich Treiber, Reutlingen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/126,717

(22) Filed: May 11, 2005

(30) Foreign Application Priority Data
May 11, 2004 (EP) 04 011 136.1

(51) Int. Cl. H04B 10/06

(52) U.S. Cl. 398/208

(57) ABSTRACT

The circuit offset at any temperature can be calculated from measurements with and without an equivalent substituted load via the new photodetector arrangement in which a switch is added to the typical photodetector arrangement, with the switch permitting the switching out of the opto-electrical converter and the subsequent connection of an electrical equivalent substituted load and a no-load connection hookup. The opto-electrical converter's internal resistance at the temperature in question and at that moment in time is determined from the known physical characteristics of the opto-electrical converter. The measurements with and without the equivalent substituted load can be carried out during the measurement operation of the circuit arrangement, so that a considerably more accurate measured value that corresponds to the ambient conditions, particularly at low optical outputs, can be ascertained by means of the new photodetector arrangement and the process.

### BACKGROUND OF THE INVENTION

A. Field of the Invention

The present invention pertains to a photodetector arrangement for the measurement of optical powers.

B. Discussion of the Related Art

A circuit arrangement as described above is known from U.S. Pat. No. 6,700,654 B2. Such an arrangement is used, for example, for monitoring the status of an optical transmission line in order to carry out an optical output measurement by means of a transmission level indicator, or by means of a spectrum analyzer. The optical signal is hereby registered by means of an opto-electrical converter, e.g., a photodiode or phototransistor, amplified, and then appropriately evaluated digitally. However, these opto-electrical converters give rise to difficulties when measuring optical intensity: this is because these opto-electrical converters are provided with a semiconductor diode, which is negatively biased, as the light-sensitive electrical devices. As a consequence, a very small current flows even in the absence of light, this current being termed the dark current. A current is produced as soon as light impinges on the photodiode, and this current is detected via an appropriate electronic circuit that is serially connected downstream. However, this signal comprises the photocurrent as a consequence of the incident light and also the dark current that is independent of the data signal. Since the photocurrent is utilized as the current that is measured, the dark current represents an interfering signal that influences the accuracy of the measurement. The dark current is thus especially hard to compensate for because it depends strongly on the temperature of the photodiode and that of the amplifier. For this reason, among others, the photodiode is operated at a constant temperature in many devices. However, the temperature can only be regulated to a limited extent. Variations in temperature therefore limit the sensitivity of the system.

Among other things, the proposal is made according to U.S. Pat. No. 6,700,654 B2 that a known signal be sent through the photodiode in addition to the signal to be detected, and that the acquired value then be extracted in order to characterize the photodiode or other electrical circuits. This system also contains a temperature sensor and storage devices in order to store the system response values at defined temperatures, and after measuring the temperature, to correct the system response value according to the measured temperature by means of the stored system response values.

Thus there is a need to improve the accuracy during the measurement of a photocurrent, especially in the case of low levels and changing ambient conditions, particularly changes in temperature.

### SUMMARY OF THE INVENTION

According to the invention, this problem is solved by means of a photodetector arrangement with the features of the main claim, along with a process for calibrating such a photodetector arrangement. Further advantageous embodiments can be seen in the pertinent back-referenced subsidiary claims.

The present invention pertains to a photodetector arrangement for the measurement of optical powers with an opto-electrical converter for registering an optical signal and generating an electrical signal; an amplifier for amplifying the signal that is received by the opto-electrical converter and for producing an electrical voltage signal; an A/D converter after the amplifier; a signal processing device with a [data] storage device that receives and additionally processes the digital signals from the A/D converter; as well as a temperature sensor in connection with the signal processing device. The invention also pertains to a process for calibrating such a photodetector arrangement as a function of ambient parameters, particularly the temperature, during the measurement operation.

The photodetector arrangement according to the invention has a circuit device between the photoelectric converter and the amplifier, this enabling, preferably by means of electronic switches, replacement of the opto-electrical converter by an equivalent substituted load or by a no-load hook up. As a result, the circuit offset can be calculated from measurements with and without the equivalent substituted load and the temperature. The internal resistance of the opto-electrical converter is needed in order to do this. In the case of standard calibration, this internal resistance has to be ascertained for the photodetector arrangement on one occasion at room temperature, and then it has to be stored in the data storage system. The actual internal resistance when there is a given ambient temperature can be determined from the known physical characteristics of the opto-electrical converter, e.g., a photodiode. The offset determined is subtracted from the result of the measurement, so that this is consequently corrected as a function of the temperature, and is thus more accurate.

According to the process according to the invention, calibration of the photodetector arrangement is effected such that the amplifier output voltage signal is measured during no-load operation and also upon connecting the ancillary resistance. The calculation of the output voltage at the amplifier by the signal processing device then takes place, with this corresponding to the dark current factoring in the stored opto-electrical converter resistance values and that correspond to the temperature at that moment. The opto-electrical converter voltage level determined when a measurement is made is corrected via the voltage signal at the output of the amplifier at the current temperature, with this voltage signal corresponding to the dark current. This calibration process can be carried out during the actual measurement process via momentary electronic switching to the no-load position and to the ancillary resistance. Thus temperature adaptation of the dark current and correction of the measurement can be carried out at ascertainable time intervals.

The determination of the internal resistance of the opto-electrical converter for making the arrangement more complete during standard calibration takes place at a defined temperature without photodetection, i.e. the current through the opto-electrical converter is equal to zero. Sequential measurements are then made of the voltage signal at the output of the amplifier during no-load operation, with the opto-electrical converter, and with the ancillary resistance alone, and the internal resistance of the opto-electrical converter is calculated from the results of the measurements.

### BRIEF DESCRIPTION OF THE DRAWINGS

The present invention will be explained in more detail below by means of the single diagram using the example of a photodiode.

FIG. 1 is a circuit diagram of a detector arrangement according to the present invention.

### DESCRIPTION OF THE INVENTION

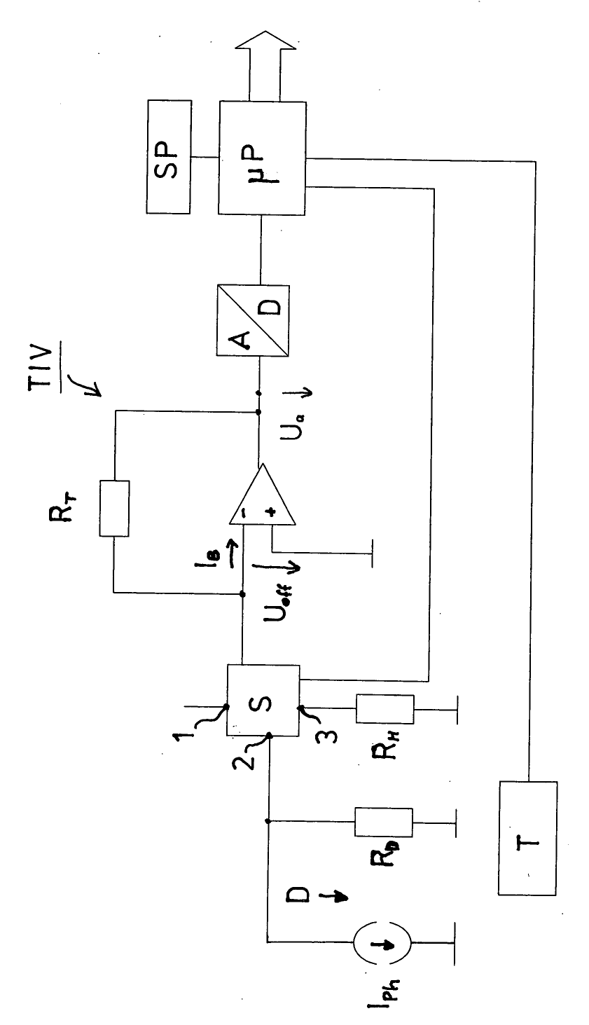

FIG. 1 illustrates a detector arrangement and shows a substituted circuit diagram for a photodiode D with a source of current which produces the constant current I_{Ph} and to which the internal resistance R_{D} of the photodiode D is connected in parallel. The photodiode is usually connected to a trans-impedance amplifier TIA that, according to the diagram, is connected to the resistance R_{T} and exhibits a bias current I_{B} and an offset voltage U_{off} at its output. The output voltage signal Uₐ is digitized by means of the A/D converter AD and forwarded to a signal processing device μP. This is connected to a storage device S and a temperature sensor T that measures either the temperature at the photodiode or the ambient temperature at the photodetector arrangement overall. According to the invention, an electronic switch S is located between the trans-impedance amplifier TIA and the photodiode D, with this electronic switch being operable by means of the signal processing device μP. The switch permits connecting the trans-impedance amplifier TIA to a no-load terminal 1, to a terminal 2 for the photodiode D, and to a terminal 3 on an ancillary resistance R_{H}.

The equation Uₐ=Iₚₕ•R_{T} applies if the bias current I_{B} and the offset voltage U_{off} are neglected, whereby the photodiode current Iₚₕ is proportional to the optical output. In the case of small photocurrents (<≈100 pA), account must be taken of the bias current I_{B} and of the offset voltage U_{off}.

In order for an exact measurement to be possible during the actual measurement, the resistance R_{D23} at room temperature has to be measured for the photodetector arrangement and then stored. This is effected in a simple manner by the photodetector arrangement according to the invention by bringing the switch S into all three positions at a photodiode current Iₚₕ=0 and then measuring the respective output voltage at the trans-impedance amplifier TIA. The following three equations hereby result, with the indices corresponding to the switch positions:
Uₐₒ₁=I_{B}•R_{T}+U_{off} (1)
Uₐₒ₂=I_{B}•R_{T}+U_{off}(1+R_{T}/R_{D}) (2)
Uₐₒ₃=I_{B}•R_{T}+U_{off}(1+R_{T}/R_{H}). (3)

The resistance of the diode R_{D23} at room temperature can be determined from these three equations with three unknowns (R_{D}, I_{B}, U_{off}).

The following equation then applies for a measurement operation at any desired temperature δ:
Uₐ=I_{Ph}•R_{T}+U_{aoδ}. (4)
with
U_{aoδ}=I_{Bδ}•R_{T}+U_{offδ}(1+R_{T}/R_{Dδ}). (5)

The dark current voltage U_{a0δ} at any desired temperature is ascertained during the measurement and subtracted from the actual result of the measurement so that an accurate, temperature-independent measurement result becomes available. This is affected such that, during the measurement, the switch S is switched momentarily from the normal measurement position 2 to the no-load position 1, and thus a measurement is made of the voltage:
U_{a0δ1}=I_{Bδ}•R_{δ}+U_{offδ}. (6)

Correspondingly, the switch S is then momentarily switched over to position 3 and, in this way, a measurement is made of the voltage:
U_{a0δ3}=I_{Bδ}•R_{δ}+U_{offδ}(1+R_{T}/R_{H}). (7)

The bias current I_{Bδ} and the offset voltage U_{offδ} at the actual temperature δ can be determined from these two equations.

Since the characteristics of photodiodes as a function of temperature are known from the literature, these can be stored, independently of the type of photodiode in question, in addition to the resistance value R_{D23} that is ascertained at room temperature.

Hereby, the following equations apply:

in the case of InGaAs: R_{Dδ}=R_{D23}•10^{-A}, and

in the case of germanium: R_{Dδ}=R_{D23}•10^{-B}, with A=(δ−23)/45 and B=(δ−23)/20.

The temperature δ is measured by the temperature sensor T, so that the dark current output voltage U_{a0δ} at the temperature R_{Dδ} at that moment in time can be calculated with the signal processing device by means of equation (5), and the data stored in storage system SP for the characteristics of the photodiodes and for the diode resistance R_{D23} at room temperature. This value is then to be subtracted from the measured voltage signal by the signal processing device μP.

Switching of the switch S and measurement of the voltages U_{a0δ1} and U_{a0δ3} and of the temperature δ can take place during the measurement in a time of <0.5 sec in a manner unnoticed by the user. The process is thus affected in a background manner relative to the user, and it increases the accuracy of measurement quite considerably with relatively simple devices. Since, depending on the set-up and the usage sector, the humidity and the electromagnetic compatibility (EMC) of the photodetector arrangement in question influence the dark current of the opto-electrical converter, account can thus be taken of changed ambient conditions—compared to calibration on a single occasion—prior to bringing the photodetector arrangement into operation.

The present invention is not to be considered limited in scope by the preferred embodiment described in the specification. Additional advantages and modifications, which readily occur to those skilled in the art from consideration and practice of this invention are intended to be within the scope and spirit of the following claims:

1. Photodetector arrangement for the measurement of optical powers, with an opto-electrical converter for receiving an optical signal and generating an electrical signal, comprising:
an amplifier for amplifying the signal received from the opto-electrical converter and for producing an electrical voltage signal;
an A/D converter following the amplifier;
a signal processing device with a storage device that receives and additionally processes the digital signals from the A/D converter; and
a temperature sensor in combination with the signal processing device,
wherein a switching device between the opto-electrical converter and the amplifier for switching the amplifier over to an ancillary resistance, to the opto-electrical converter, or to a no-load hookup.

2. The photodetector arrangement according to claim 1, wherein the switching device is an electronic switching device that is connected to the signal processing device.

3. Process according to claim 1, for calibrating a photodetector as a function of ambient parameters, particularly the temperature, during the measurement operation, wherein the process comprises the following steps:
measurement of the voltage signal at the output of the amplifier in the case of no-load operation after switching the switch over to the no-load hookup;
measurement of the voltage signal at the output of the amplifier after switching the switch over to the ancillary resistance, calculation of the output voltage at the output of amplifier by the signal processing unit, this output voltage corresponding to the dark current, with account being taken of the opto-electrical converter's resistance values that are stored in the storage system and that correspond to the temperature at that moment; and
determination of the opto-electrical converter's voltage level during the measurement operation after switching over to the opto-electrical converter and correcting with the dark current voltage signal at the output of the amplifier at the temperature at that moment.

4. The process according to claim 3, wherein the internal resistance of the opto-electrical converter is ascertained on one occasion at a defined temperature for the photodetector arrangement prior to carrying out the measurements, and then this is stored in the storage system.

5. The process according to claim 4, wherein the internal resistance corresponding to the respective temperature is calculated by the signal processing device on the basis, in each case, of the internal resistance of the opto-electrical converter and according to the opto-electrical converter that is used.

6. The process according to claim 4, wherein the internal resistance is ascertained at a defined temperature by measuring the voltage signal without photo-detection, with i=the position of the switch, namely at the output of the amplifier, after switching the switch over to the no-load position (i=1), and to the opto-electronic converter position (i=2), and to the ancillary resistance position (i=3), and by carrying out a calculation on the basis of the measurement results.

7. The process according to claim 3, wherein during the measurement operation, the switch is momentarily switched over by the signal processing unit in order to determine the temperature-dependent dark current correction value.

8. A photodetector arrangement for the measurement of optical powers, with an opto-electrical converter for receiving an optical signal and generating an electrical signal, comprising:
an amplifier for amplifying the signal received from the opto-electrical converter and for producing an electrical voltage signal;
an A/D converter coupled to the output of the amplifier;
a temperature sensor;
a multiplexer having a first input coupled to a no-load, a second input coupled to the opto-electrical converter, a third input coupled to a reference resistance and an output coupled to the amplifier, the multiplexer operable to couple a selected one of the multiplexer inputs to the multiplexer output;
a signal processor coupled to the temperature sensor and the A/D converter, and operable to perform calculations based on the temperature sensor and the digital signals from the A/D converter for calibration of the opto-electrical converter.

9. The photodetector arrangement according to claim 8, wherein the signal processor:
measures a first voltage signal at the output of the amplifier while the multiplexer connects the first input to the multiplexer output;
measures a second voltage signal at the output of the amplifier while the multiplexer connects the second input to the multiplexer output;
measures a third voltage signal at the output of the amplifier while the multiplexer connects the third input to the multiplexer output;
calculates a compensation voltage based on the first, second and third voltage signals and an output from the temperature sensor.
